(19) United States
(12) Patent Application Publication
(10) Pub. No.: US 2024/0343634 A1
(43) Pub. Date: Oct. 17, 2024

(54) OPTICAL GLASS, GLASS PREFORM, OPTICAL ELEMENT AND OPTICAL INSTRUMENT

(71) Applicant: CDGM GLASS CO., LTD, Chengdu, Sichuan (CN)

(72) Inventor: Bo KUANG, Chengdu (CN)

(73) Assignee: CDGM GLASS CO., LTD, Chengdu, Sichuan (CN)

(21) Appl. No.: 18/294,432

(22) PCT Filed: Aug. 17, 2022
(86) PCT No.: PCT/CN2022/112977

§ 371 Date: Feb. 1, 2024

(30) Foreign Application Priority Data
Sep. 7, 2021 (CN) 202111047093.X

(51) Int. Cl. C03C 3/068; C03C 3/064; C03C 4/20

(52) U.S. Cl. CPC C03C 3/068; C03C 3/064; C03C 4/20; C03C 2204/00

(57) ABSTRACT

An optical glass, wherein components of the optical glass are represented by weight percentage, including: 12-30% of SiO₂; 6-20% of Nb₂O₅; 15-35% of TiO₂; 15-35% of BaO; 1-10% of ZrO₂. Through rational component proportion, the optical glass obtains the optical glass with a refractive index of 1.89-1.96 and an Abbe number of 20-28 in silicate (borate) system; the cost for raw material and production of this optical glass is lower, and the environmental load is smaller.

### TECHNICAL FIELD

The present invention relates to an optical glass, in particular to an optical glass with a refractive index of 1.89-1.96 and an Abbe number of 20-28.

### BACKGROUND

The glass with refractive index of 1.89-1.96 and Abbe number of 20-28 belongs to flint glass with high refractive index. Such glass has higher refractive index and dispersion. When such glass is coupled with coronal glass, chromatic aberration and secondary spectrum can be effectively eliminated. At the same time, total optical length of lens can be effectively shortened to miniaturize the imaging system. Therefore, this type of glass has a broad application prospect in optical design.

In the prior art, the flint glass with high refractive index usually adopts P₂O₅—Nb₂O₅—TiO₂—RO glass system (i.e., phosphate system), such as an optical glass with refractive index of 1.80-1.95 and Abbe number of 19-28 disclosed in CN200710088277.4. Compared with silicate (borate) glass system, phosphate system glass has the following problems: 1) the production of the phosphate system glass is more difficult than that of silicate (borate) glass, and the production cost is higher; 2) the raw material cost of the phosphate system glass is higher than that of the silicate (borate) glass; 3) the phosphate glass is higher than the silicate (borate) glass in terms of platinum vessel corrosion (consumption) used in the production process, and meanwhile the platinum vessel that has been used for producing phosphate glass requires special purification treatment during recycling, thereby further increasing the production cost; 4) phosphate glass has greater environmental load during production. Based on the reasons above, how to obtain flint glass with refractive index of 1.89-1.96 and Abbe number of 20-28 in the silicate (borate) glass system has become a new topic in optical glass research.

### SUMMARY

A technical problem to be solved by the present invention is to provide a flint optical glass with a refractive index of 1.89-1.96 and an Abbe number of 20-28.

To solve the technical problem, the technical scheme of the present invention provides:

An optical glass, wherein components thereof are represented by weight percentage, comprising: 12-30% of SiO₂; 6-20% of Nb₂O₅; 15-35% of TiO₂; 15-35% of BaO; 1-10% of ZrO₂.

Furthermore, the optical glass, wherein components thereof are represented by weight percentage, further comprising: 0-6% of B₂O₃; and/or 0-10% of WO₃; and/or 0-8% of ZnO; and/or 0-3% of Li₂O; and/or 0-8% of Na₂O; and/or 0-5% of K₂O; and/or 0-8% of SrO; and/or 0-12% of CaO; and/or 0-8% of MgO; and/or 0-10% of Ln₂O₃; and/or 0-5% of Al₂O₃; and/or 0-1% of clarifying agent, the Ln₂O₃ is one or more of La₂O₃, Gd₂O₃, Y₂O₃, and Yb₂O₃, and the clarifying agent is one or more of Sb₂O₃, SnO₂, SnO, and CeO₂.

An optical glass, wherein components thereof are represented by weight percentage, consisting of: 12-30% of SiO₂; 6-20% of Nb₂O₅; 15-35% of TiO₂, 15-35% of BaO; 1-10% of ZrO₂; 0-6% of B₂O₃; 0-10% of WO₃; 0-8% of ZnO; 0-3% of Li₂O; and 0-8% of Na₂O; 0-5% of K₂O; 0-8% of SrO; 0-12% of CaO; 0-8% of MgO; 0-10% of Ln₂O₃; 0-5% of Al₂O₃; 0-1% of clarifying agent, the Ln₂O₃ is one or more of La₂O₃, Gd₂O₃, Y₂O₃, and Yb₂O₃, and the clarifying agent is one or more of Sb₂O₃, SnO₂, SnO, and CeO₂.

Furthermore, the optical glass, wherein components thereof are represented by weight percentage, in which: Nb₂O₅/BaO is 0.2-1.2, Nb₂O₅/BaO is preferably 0.2-1.0, Nb₂O₅/BaO is more preferably 0.25-0.9, and Nb₂O₅/BaO is further preferably 0.3-0.8.

Furthermore, the optical glass, wherein components thereof are represented by weight percentage, in which: TiO₂/(Nb₂O₅+ZrO₂) is 0.6-5.5, TiO₂/(Nb₂O₅+ZrO₂) is preferably 0.7-4.0, TiO₂/(Nb₂O₅+ZrO₂) is more preferably 0.8-3.0, and TiO₂/(Nb₂O₅+ZrO₂) is further preferably 1.0-2.5.

Furthermore, the optical glass, wherein components thereof are represented by weight percentage, in which: SiO₂/(Nb₂O₅+TiO₂) is 0.3-1.3, SiO₂/(Nb₂O₅+TiO₂) is preferably 0.35-1.0, and SiO₂/(Nb₂O₅+TiO₂) is more preferably 0.4-0.8.

Furthermore, the optical glass, wherein components thereof are represented by weight percentage, in which: B₂O₃/SiO₂ is below 0.4, B₂O₃/SiO₂ is preferably 0.01-0.3, and B₂O₃/SiO₂ is more preferably 0.03-0.2.

Furthermore, the optical glass, wherein components thereof are represented by weight percentage, in which: Na₂O/CaO is below 5.0, Na₂O/CaO is preferably 0.01-3.0, and Na₂O/CaO is more preferably 0.05-2.5.

Furthermore, the optical glass, wherein components thereof are represented by weight percentage, in which: (ZnO+SrO+Ln₂O₃)/SiO₂ is below 0.7, (ZnO+SrO+Ln₂O₃)/SiO₂ is preferably below 0.6, (ZnO+SrO+Ln₂O₃)/SiO₂ is more preferably below 0.5, and (ZnO+SrO+Ln₂O₃)/SiO₂ is further preferably below 0.3.

Furthermore, the optical glass, wherein components thereof are represented by weight percentage, in which: Li₂O/B₂O₃ is below 0.5, Li₂O/B₂O₃ is preferably below 0.3, Li₂O/B₂O₃ is more preferably below 0.1, and Li₂O/B₂O₃ is further preferably below 0.05.

Furthermore, the optical glass, wherein components thereof are represented by weight percentage, in which: (SiO₂+TiO₂)/(Nb₂O₅+ZrO₂+CaO+BaO) is 0.5-2.2, (SiO₂+TiO₂)/(Nb₂O₅+ZrO₂+CaO+BaO) is preferably 0.6-2.0, (SiO₂+TiO₂)/(Nb₂O₅+ZrO₂+CaO+BaO) is more preferably 0.8-1.8, and (SiO₂+TiO₂)/(Nb₂O₅+ZrO₂+CaO+BaO) is further preferably 0.9-1.5.

Furthermore, the optical glass, wherein components thereof are represented by weight percentage, in which: 10×Li₂O/Nb₂O₅ is below 0.7, 10×Li₂O/Nb₂O₅ is preferably below 0.4, and 10×Li₂O/Nb₂O₅ is more preferably below 0.2.

Furthermore, the optical glass, wherein components thereof are represented by weight percentage, in which: SiO₂ is 15-25%, SiO₂ is preferably 16-23%; and/or Nb₂O₅ is 7-18%, Nb₂O₅ is preferably 8-17%; and/or TiO₂ is 18-32%, TiO₂ is preferably 20-30%; and/or BaO is 18-32%, BaO is preferably 20-30%; and/or ZrO₂ is 2-8%, ZrO₂ is preferably 2-7%; and/or B₂O₃ is 0.1-5%, B₂O₃ is preferably 0.5-4%; and/or WO₃ is 0-5%, WO₃ is preferably 0-2%; and/or ZnO is 0-5%, ZnO is preferably 0-2%; and/or Li₂O is 0-2%, Li₂O is preferably 0-1%; and/or Na₂O is 0-6%, Na₂O is preferably 0.5-5%; and/or K₂O is 0-3%, K₂O is preferably 0-2%; and/or SrO is 0-4%, SrO is preferably 0-2%; and/or CaO is 1-9%, CaO is preferably 3-7%; and/or MgO is 0-4%, MgO is preferably 0-2%; and/or Ln₂O₃ is 0-9%, Ln₂O₃ is preferably 0-7%; and/or Al₂O₃ is 0-3%, Al₂O₃ is preferably 0-2%; and/or clarifying agent is 0-0.5%, clarifying agent is preferably 0-0.2%, the Ln₂O₃ is one or more of La₂O₃, Gd₂O₃, Y₂O₃, and Yb₂O₃, and the clarifying agent is one or more of Sb₂O₃, SnO₂, SnO, and CeO₂.

Furthermore, the optical glass does not contain ZnO; and/or does not contain Li₂O; and/or does not contain P₂O₅; and/or does not contain Bi₂O₃; and/or does not contain Ta₂O₅; and/or does not contain TeO₂, and/or does not contain WO₃.

Furthermore, refractive index n_{d} of the optical glass is 1.89-1.96, preferably 1.90-1.95, more preferably 1.91-1.94; and Abbe number v_{d} is 20-28, preferably 21-27, more preferably 22-26.

Furthermore, λ₇₀ of the optical glass is below 460 nm, λ₇₀ is preferably below 450 nm, λ₇₀ is more preferably below 440 nm; and/or λ₅ is below 400 nm, λ₅ is preferably below 390 nm, as is more preferably below 380 nm; and/or acid resistance stability D_{A} is above Class 2, preferably Class 1; and/or water resistance stability D_{W} is above Class 2, preferably Class 1; and/or upper limit of devitrification temperature is below 1200° C., preferably below 1160° C., more preferably below 1150° C., further preferably below 1140° C.; and/or Young's modulus E is above 9000×10⁷/Pa, preferably above 9500×10⁷/Pa, more preferably above 10000×10⁷/Pa, further preferably above 10500×10⁷/Pa; and/or thermal expansion coefficient α_{100-300° C.} is below 110×10⁻⁷/K, preferably below 105×10⁻⁷/K, more preferably below 100×10⁻⁷/K; density ρ is below 4.30 g/cm³, preferably below 4.20 g/cm³, more preferably below 4.10 g/cm³; and/or abrasion degree F_{A} is above 150, preferably above 180, more preferably 200-300; and/or relative partial dispersion P_{g,F} is 0.6000-0.6500, preferably 0.6100-0.6400, more preferably 0.6150-0.6250.

A glass preform is made of the above-mentioned optical glass.

An optical element, made of the above-mentioned optical glass or made of the above-mentioned glass preform.

An optical instrument, comprising the above-mentioned optical glass, or comprising the above-mentioned optical element.

The beneficial effects of the present invention are as follows: through rational component proportion, the optical glass of the present invention obtains the optical glass with a refractive index of 1.89-1.96 and an Abbe number of 20-28 in silicate (borate) system; the cost for raw material and production of this optical glass is lower, and the environmental load is smaller.

### DETAILED DESCRIPTION

The implementations of the optical glass provided by the present invention will be described in detail below, but the present invention is not limited to the following implementations. Appropriate changes may be made within the scope of the purpose of the present invention for implementation. In addition, the repeated descriptions will not limit the aim of the present invention although with appropriate omissions. The optical glass provided by the present invention is sometimes referred to as glass in the following content.

### [Optical Glass]

Hereinafter, the components of the optical glass provided by the present invention will be described. If not specified herein, the content of each component is expressed in weight percentage (wt %) relative to the total glass materials converted into oxide composition. “Converted into oxide composition” therein refers to that the total weight of this oxide is taken as 100% when the oxide, compound salt and hydroxide, used as raw materials for the composition of the optical glass of the present invention, are decomposed and transformed into oxides during melting.

Unless otherwise noted in specific circumstances, the numerical range listed herein includes upper and lower limits, and the words “above” and “below” include the endpoint values as well as all integers and fractions within the range, but not limited to the specific values listed when the range is limited. The term “about” as used herein refers to that formulations, parameters and other quantities as well as characteristics are not, and do not need to be, accurate, and may be approximate and/or greater or lower if necessary, reflecting tolerances, conversion factors, measurement errors, etc. “And/or” mentioned herein is inclusive. For example, “A and/or B” refers to only A, or only B, or both A and B.

### <Necessary and Unnecessary Components>

SiO₂, as a network forming body of the glass provided by the present invention, features having the viscosity that maintains chemical stability and is suitable for the molding of molten glass, increasing the devitrification resistance of the glass, and decreasing the erosion of molten glass liquid to refractory materials. If the content of SiO₂ is lower than 12%, it is difficult to achieve the above-mentioned effect. Therefore, the lower limit of the content of SiO₂ is 12%, preferably 15%, more preferably 16%. If the content of SiO₂ is higher than 30%, the melting performance of the glass will decrease, and the transition temperature will rise. Therefore, the upper limit of the content of SiO₂ is 30%, preferably 25%; more preferably 23%. In some implementations, it can comprise about 12%, 12.5%, 13%, 13.5%, 14%, 14.5%, 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 25.5%, 26%, 26.5%, 27%, 27.5%, 28%, 28.5%, 29%, 29.5% or 30% of SiO₂.

B₂O₃ can improve the thermal stability of the glass, increase the melting performance of the glass, inhibit the rapid escape of gas when the raw material is melted in order to avoid “cylinder” problem. An appropriate amount of B₂O₃ can enable it to be easier to obtain the glass without molten residue of glass raw material. However, when the content of B₂O₃ is excessive, the refractive index of the glass decreases and the thermal stability becomes poor. Therefore, the content of B₂O₃ in the present invention is below 6%, preferably 0.1-5%, more preferably 0.5-4%. In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.5%, 4%, 4.5%, 5%, 5.5%, or 6% of B₂O₃.

In some implementations of the present invention, the ratio of the content of B₂O₃ to the content of SiO₂, i.e., B₂O₃/SiO₂, is controlled to be below 0.4, which is conducive to improving the chemical stability of the glass. Therefore, B₂O₃/SiO₂ is preferably below 0.4. Furthermore, it is also conducive to optimizing the Young's modulus and abrasiveness of the glass by making B₂O₃/SiO₂ within a range of 0.01-0.3. Therefore, B₂O₃/SiO₂ is more preferably 0.01-0.3, and B₂O₃/SiO₂ is further preferably 0.03-0.2. In some implementations, the value of B₂O₃/SiO₂ can be 0, greater than 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4.

Nb₂O₅, a high-refraction high-dispersion component, can increase the refractive index and devitrification resistance of the glass, and decrease the thermal expansion coefficient of the glass. The present invention obtains the above-mentioned effect by comprising over 6% of Nb₂O₅. The content of Nb₂O₅ is preferably over 7%, more preferably over 8%. If the content of Nb₂O₅ exceeds 20%, the thermal stability and chemical stability of the glass will be decreased and the light transmittance will be reduced. Therefore, the upper limit of the content of Nb₂O₅ in the present invention is 20%, preferably 18%, more preferably 17%. In some implementations, it can comprise about 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5% or 20% of Nb₂O₅.

TiO₂ can increase the refractive index and dispersion of the glass and can be involved in the formation of glass network. An appropriate amount of TiO₂ can make the glass more stable and decrease the high-temperature viscosity of the glass. The present invention obtains the above-mentioned effect by comprising above 15% of TiO₂, preferably comprising above 18% of TiO₂, more preferably comprising above 20% of TiO₂. If the content of TiO₂ exceeds 35%, devitrification of the glass will tend to increase and the transition temperature will rise, and meanwhile the glass will become easy to stain during press molding. Therefore, the content of TiO₂ in the present invention is below 35%, the content of TiO₂ is preferably below 32%, more preferably below 30%. In some implementations of the present invention, it can comprise about 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 25.5%, 26%, 26.5%, 27%, 27.5%, 28%, 28.5%, 29%, 29.5%, 30%, 30.5%, 31%, 31.5%, 32%, 32.5%, 33%, 33.5%, 34%, 34.5% or 35% of TiO₂.

In some implementations of the present invention, by controlling the ratio of the content of SiO₂ to the total content of Nb₂O₅ and TiO₂ (Nb₂O₅+TiO₂), i.e., SiO₂/(Nb₂O₅+TiO₂) within a range of 0.3-1.3, it is beneficial for the glass to obtain the appropriate abrasiveness and relative partial dispersion while decreasing the thermal expansion coefficient and density of the glass. Therefore, SiO₂/(Nb₂O₅+TiO₂) is preferably 0.3-1.3, SiO₂/(Nb₂O₅+TiO₂) is more preferably 0.35-1.0, and SiO₂/(Nb₂O₅+TiO₂) is further preferably 0.4-0.8. In some implementations of the present invention, the value of SiO₂/(Nb₂O₅+TiO₂) can be 0.3, 0.35, 0.4, 0.45, 0.5, 0.55, 0.6, 0.65, 0.7, 0.75, 0.8, 0.85, 0.9, 0.95, 1.0, 1.05, 1.1, 1.15, 1.2, 1.25 or 1.3.

WO₃ can enhance the refractive index and dispersion of the glass, but the effect is not as good as Nb₂O₅ and TiO₂, and it does not enjoy a cost advantage. Meanwhile, it will also lead to a decrease in light transmittance of the glass. Therefore, the content of WO₃ in the present invention is 0-10%, preferably 0-5%, more preferably 0-2%, further preferably 0%, In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% of WO₃.

ZnO can adjust the refractive index and dispersion of the glass, and decrease the transition temperature of the glass. However, if the content of ZnO exceeds 8%, devitrification resistance of the glass will be reduced, and meanwhile the high-temperature viscosity will be small to bring difficulties to the molding, and increase the thermal expansion coefficient and refractive index temperature coefficient of the glass. Therefore, the content of ZnO in the present invention is 0-8%, preferably 0-5%, more preferably 0-2%. In some implementations, it further preferably contains no ZnO. In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5% or 8% of ZnO.

Li₂O can decrease the transition temperature of the glass and improve the melting performance of the glass. However, if the content of Li₂O is high, it will not be conducive to the chemical stability, devitrification resistance capability and thermal expansion coefficient of the glass. Therefore, the content of Li₂O in the present invention is below 3%, preferably below 2%, more preferably below 1%. In some implementations, it further preferably contains no Li₂O. In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9% or 3% of Li₂O_{.}

In some implementations of the present invention, by making the ratio of the content of Li₂O to the content of B₂O₃, i.e., Li₂O/B₂O₃, to be below 0.5, it can increase the chemical stability of the glass and the resistance to surface devitrification of secondary compression, and optimize the abrasiveness of the glass. Therefore, Li₂O/B₂O₃ is preferably below 0.5, Li₂O/B₂O₃ is more preferably below 0.3, Li₂O/B₂O₃ is further preferably below 0.1, and Li₂O/B₂O₃ is more further preferably below 0.05. In some implementations, the value of Li₂O/B₂O₃ can be 0, greater than 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49 or 0.5.

In some implementations of the present invention, by making 10×Li₂O/Nb₂O₅ to be below 0.7, it is conductive to increasing the chemical stability of the glass and the resistance to devitrification of secondary compression, and increasing the Young's modulus of the glass. Therefore, 10×Li₂O/Nb₂O₅ is preferably below 0.7, 10×Li₂O/Nb₂O₅ is more preferably below 0.4, and 10×Li₂O/Nb₂O₅ is further preferably below 0.2. In some implementations of the present invention, the value of 10×Li₂O/Nb₂O₅ can be 0, greater than 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.55, 0.6, 0.65 or 0.7.

Na₂O can improve the melting performance of the glass and increase the melting effect of the glass, and meanwhile can decrease the transition temperature of the glass. In the present invention, an appropriate amount of Na₂O can also improve the light transmittance of the glass. If the content of Na₂O exceeds 8%, the chemical stability and weather resistance of the glass will be decreased. Therefore, the content of Na₂O is 0-8%, the content of Na₂O is preferably 0-6%, and the content of Na₂O is more preferably 0.5-5%. In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5% or 8% of Na₂O.

K₂O can improve the thermal stability and melting performance of the glass. However, if the content of K₂O exceeds 5%, the devitrification resistance and chemical stability of the glass will deteriorate. Therefore, the content of K₂O in the present invention is below 5%, and the content of K₂O is preferably below 3%, more preferably below 2%. In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or 5% of K₂O.

MgO can decrease the refractive index and melting temperature of the glass. However, in case of excessive MgO content, the refractive index of the glass will fail to meet the design requirements, and the devitrification resistance and stability of the glass will be reduced, and meanwhile the cost of the glass will rise. Therefore, the content of MgO is confined to 0˜8%, preferably 0-4%, more preferably 0-2%. In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5% or 8% of MgO.

CaO helps to adjust the optical constant of the glass, improve the processing performance of the glass, and decrease the density of the glass. However, in case of excessive CaO content, the optical constant of the glass will fail to meet the design requirements, and the devitrification resistance will deteriorate. Therefore, the content of CaO is confined to 0-12%, preferably 1-9%, more preferably 3-7%. In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5% or 12% of CaO.

In some implementations of the present invention, by controlling the ratio of the content of Na₂O to the content of CaO, i.e., Na₂O/CaO, to be below 5.0, it can increase the devitrification resistance of the glass. Therefore, Na₂O/CaO is preferably below 5.0. Furthermore, by controlling Na₂O/CaO within a range of 0.01-3.0. it is also conducive to increasing the light transmittance and Young's modulus of the glass. Therefore, Na₂O/CaO is more preferably 0.01-3.0, and Na₂O/CaO is further preferably 0.05-2.5. In some implementations of the present invention, the value of Na₂O/CaO can be 0, greater than 0, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 or 5.0.

SrO can adjust the refractive index and Abbe number of the glass. However, if the content of SrO is excessive, the chemical stability of the glass will be decreased, and meanwhile the cost of the glass will also rise rapidly. Therefore, the content of SrO is confined to 0˜8%, preferably 0-4%, more preferably 0-2%. In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1, 1.5%, 2%, 2.5%, 3%, 3.5%, 4%, 4.5%, 5%, 5.5%, 6%, 6.5%, 7% 7.5% or 8% of SrO.

BaO is a necessary component for adjusting the refractive index and improving the transmittance and strength of the glass in the present invention. When the content of BaO is less than 15%, the above-mentioned effect is not obvious. The lower limit of the content of BaO is preferably 18%, and the lower limit of the content of BaO is more preferably 20%. On the other hand, if the content of BaO exceeds 35%, the devitrification resistance and chemical stability of the glass will become poor, and the density will increase significantly. Therefore, the upper limit of the content of BaO is 35%, preferably 32%; more preferably 30%. In some implementations of the present invention, it can comprise about 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 25.5%, 26%, 26.5%, 27%, 27.5%, 28%, 28.5%, 29%, 29.5%, 30%, 30.5%, 31%, 31.5%, 32%, 32.5%, 33%, 33.5%, 34%, 34.5% or 35% of BaO.

In some implementations of the present invention, by controlling the ratio of the content of Nb₂O₅ to the content of BaO, i.e., Nb₂O₅/BaO, within a range of 0.2-1.2, the glass provided by the present invention can have excellent chemical stability, and meanwhile the thermal expansion coefficient of the glass can be decreased. Therefore, Nb₂O₅/BaO is preferably 0.2-1.2, and Nb₂O₅/BaO is more preferably 0.2-1.0. Furthermore, by controlling Nb₂O₅/BaO within a range of 0.25-0.9, it can also further increase the Young's modulus of the glass. Therefore, Nb₂O₅/BaO is further preferably 0.25-0.9, and Nb₂O₅/BaO is more further preferably 0.3-0.8. In some implementations of the present invention, the value of Nb₂O₅/BaO can be 0.2, 0.25, 0.3, 0.35, 0.4, 0.45, 0.5, 0.55, 0.6, 0.65, 0.7, 0.75, 0.8, 0.85, 0.9, 0.95, 1.0, 1.05, 1.1, 1.15 or 1.2.

ZrO₂ can increase the refractive index of the glass and adjust the dispersion, and increase the devitrification resistance and strength of the glass. The present invention obtains the above-mentioned effect by comprising over 1% of ZrO₂, preferably comprising over 2% of ZrO₂. If the content of ZrO₂ is higher than 10%, the melting difficulty of the glass will increase, the melting temperature will rise, and even inclusions and transmittance of the glass are likely to reduce in the glass. Therefore, the content of ZrO₂ is below 10%, preferably below 8%, more preferably below 7%. In some implementations, it can comprise about 1%, 1.5%, 2%, 2.5%, 3%, 3.5%, 4%, 4.5%, 5% 5.5%, 6%, 6.5%, 7%, 7.5%, 8%, 8.5%, 9%, 9.5% or 10% of ZrO₂.

In some implementations of the present invention, by controlling the ratio of the content of TiO₂ to the total content of Nb₂O₅ and ZrO₂ (Nb₂O₅+ZrO₂), i.e., TiO₂/(Nb₂O₅+ZrO₂), within a range of 0.6-5.5, it is conductive to improving the devitrification resistance and light transmittance of the glass. Therefore, TiO₂/(Nb₂O₅+ZrO₂) is preferably 0.6-5.5, and TiO₂/(Nb₂O₅+ZrO₂) is more preferably 0.7-4.0. Furthermore, by controlling TiO₂/(Nb₂O₅+ZrO₂) within a range of 0.8-3.0, it can also make the glass obtain the appropriate abrasiveness and relative partial dispersion. Therefore, TiO₂/(Nb₂O₅+ZrO₂) is further preferably 0.8-3.0, and TiO₂/(Nb₂O₅+ZrO₂) is more further preferably 1.0-2.5. In some implementations of the present invention, the value of TiO₂/(Nb₂O₅+ZrO₂) can be 0.6, 0.65, 0.7, 0.75, 0.8, 0.85, 0.9, 0.95, 1.0, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4 or 5.5.

In some implementations of the present invention, by controlling the ratio of the total content of SiO₂ and TiO₂ (SiO₂+TiO₂) to the total content of Nb₂O₅, ZrO₂, CaO and BaO (Nb₂O₅+ZrO₂+CaO+BaO), i.e., (SiO₂+TiO₂)/(Nb₂O₅+ZrO₂+CaO+BaO), within a range of 0.5-2.2, it can increase the glass-forming stability and chemical stability of the glass, and decrease the density of the glass. Therefore, (SiO₂+TiO₂)/(Nb₂O₅+ZrO₂+CaO+BaO) is preferably 0.5-2.2, and (SiO₂+TiO₂)/(Nb₂O₅+ZrO₂+CaO+BaO) is more preferably 0.6-2.0. Furthermore, by controlling (SiO₂+TiO₂)/(Nb₂O₅+ZrO₂+CaO+BaO) within a range of 0.8-1.8, it can further increase the devitrification resistance of secondary compression and Young's modulus of the glass. Therefore, (SiO₂+TiO₂)/(Nb₂O₅+ZrO₂+CaO+BaO) is further preferably 0.8-1.8, and (SiO₂+TiO₂)/(Nb₂O₅+ZrO₂+CaO+BaO) is more further preferably 0.9-1.5. In some implementations of the present invention, the value of (SiO₂+TiO₂)/(Nb₂O₅+ZrO₂+CaO+BaO) can be 0.5, 0.55, 0.6, 0.65, 0.7, 0.75, 0.8, 0.85, 0.9, 0.95, 1.0, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2.0, 2.05, 2.1, 2.15 or 2.2.

Ln₂O₃ (Ln₂O₃ is one or more of La₂O₃, Gd₂O₃, Y₂O₃, and Yb₂O₃) is a component for increasing the refractive index and chemical stability of the glass. By controlling the content of Ln₂O₃ to be below 10%, it can prevent the devitrification resistance of the glass from decrease. The upper limit of the content range of Ln₂O₃ is preferably 9%, more preferably 7%. In some implementations, Ln₂O₃ is preferably La₂O₃. In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% of Ln₂O₃.

In some implementations of the present invention, by controlling the total content of ZnO, SrO, and Ln₂O₃ (ZnO+SrO+Ln₂O₃) to the content of SiO₂, i.e., (ZnO+SrO+Ln₂O₃)/SiO₂, to be below 0.7, it is conductive to decreasing the density and relative partial dispersion of the glass. Therefore, (ZnO+SrO+Ln₂O₃)/SiO₂ is preferably below 0.7, and (ZnO+SrO+Ln₂O₃)/SiO₂ is more preferably below 0.6. Furthermore, the thermal expansion coefficient of the glass can be decreased by controlling (ZnO+SrO+Ln₂O₃)/SiO₂ to be below 0.5. Therefore, (ZnO+SrO+Ln₂O₃)/SiO₂ is further preferably below 0.5, and (ZnO+SrO+Ln₂O₃)/SiO₂ is more further preferably below 0.3. In some implementations of the present invention, the value of (ZnO+SrO+Ln₂O₃)/SiO₂ can be 0, greater than 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.55, 0.6, 0.65 or 0.7.

Al₂O₃ can improve the chemical stability of the glass. However, in case of excessive Al₂O₃, the devitrification resistance and melting performance of the glass will decrease. Therefore, the content of Al₂O₃ is below 5%, preferably below 3%, more preferably below 2%. In some implementations, it can comprise about 0%, greater than 0%, 0.01%, 0.05%, 0.1%, 0.2%, 0.3%, 0.4%, 0.5%, 0.6%, 0.7%, 0.8%, 0.9%, 1%, 1.5%, 2%, 2.5%, 3%, 3.5% 4%, 4.5% or 5% of Al₂O₃.

In some implementations, the glass provided by the present invention can also comprise 0-1% of clarifying agent, in order to increase the de-foaming capability of the glass. Such clarifying agent includes, but is not limited to, one or more of Sb₂O₃, SnO₂, SnO, and CeO₂. Sb₂O₃ is preferably used as the clarifying agent. When the above-mentioned clarifying agents exist alone or in combination, the upper limit of the content of the clarifying agent is preferably 0.5%, more preferably 0.2%. In some implementations, the content of one or more of the above-mentioned clarifying agents is about 0%, greater than 0%, 0.01%, 0.05%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95% or 1%.

A small amount of other components not mentioned above can be added as required without impairing the glass characteristics of the present invention, such as P₂O₅, Bi₂O₃, Ta₂O₅, TeO₂, and Ga₂O₃ (the individual or combined content of the above-mentioned components is preferably no more than 4%, more preferably no more than 2%, further preferably no more than 1%; the content of P₂O₅ is more further preferably 0%); and/or Bi₂O₃; and/or Ta₂O₅; and/or TeO₂; and/or Ga₂O₃.

### <Unnecessary Components>

In the glass of the present invention, for the transition metal oxides such as V, Cr, Mn, Fe, Co, Ni, Cu, Ag and Mo, even if they are contained in small amounts in a single or compound form, the glass could be colored and absorb at a specific wavelength in the visible light region, thereby impairing the properties of the present invention in increasing the visible light transmittance, and therefore, in particular, for optical glass with requirement on wavelength transmittance in the visible region, it is preferably not actually included.

Th, Cd, Tl, Os, Be and Se oxides have been used in a controlled manner as a harmful chemical substance in recent years, which is necessary not only in the glass manufacturing process, but also in the processing procedure and disposal after the productization for environmental protection measures. Therefore, in the case of attaching importance to the influence on the environment, it is preferably not actually included except for the inevitable incorporation. As a result, the optical glass does not actually contain a substance that contaminates the environment. Therefore, the optical glass of the present invention can be manufactured, processed, and discarded even if a measure is not taken as a special environmental countermeasure. At the same time, in order to achieve environmental friendliness, the optical glass of the present invention preferably does not contain As₂O₃ and PbO.

The terms “not contained” and “0%” as used herein mean that the compound, molecule or element and the like are not intentionally added to the optical glass of the present invention as raw materials; however, as raw materials and/or equipment for the production of optical glass, there will be some impurities or components that are not intentionally added in small or trace amounts in the final optical glass, and this situation also falls within the protection scope of the present invention patent.

In the following paragraphs, the performance of optical glass provided in this invention will be described:

### <Refractive Index and Abbe Number>

The refractive index (n_{d}) and Abbe number (ν_{d}) of the optical glass is tested as per the method specified in GB/T 7962.1-2010.

In some implementations, the upper limit of the refractive index (n_{d}) of the optical glass provided by the present invention is 1.96, preferably 1.95, more preferably 1.94.

In some implementations, the lower limit of the refractive index (n_{d}) of the optical glass provided by the present invention is 1.89, preferably 1.90, more preferably 1.91.

In some implementations, the upper limit of the Abbe number (v_{d}) of the optical glass provided by the present invention is 28, preferably 27, more preferably 26.

In some implementations, the lower limit of the Abbe number (v_{d}) of the optical glass provided by the present invention is 20, preferably 21, more preferably 22.

### <Staining Degree>

The short-wave transmission spectrum characteristics of the glass provided by the present invention are represented by staining degree (λ₇₀ and λ₅). λ₇₀ refers to a wavelength corresponding to a glass transmittance of 70%. The measurement of λ₇₀ is carried out using a glass having a thickness of 10±0.1 mm with two opposing planes parallel to each other and optically polished, measuring the spectral transmittance in the wavelength region from 280 nm to 700 nm and a wavelength exhibiting 70% of the transmittance. The spectral transmittance or transmittance is an amount indicated by Iᵢₙ in the case where the light of an intensity Iᵢₙ is incident perpendicularly to the above surface of the glass, passes through the glass and passes an amount represented by Iₒᵤₜ/Iᵢₙ while emitting the light of an intensity Iₒᵤₜ from a plane, and includes the transmittance of the surface reflection loss on the above surface of the glass. The higher the refractive index of the glass is, the greater the surface reflection loss becomes. Therefore, in the glass with high refractive index, a small value of λ₇₀ means that the glass itself is colored very little and the light transmittance is high.

In some implementations, λ₇₀ of the optical glass provided by the present invention is below 460 nm, λ₇₀ is preferably below 450 nm, and λ₇₀ is more preferably below 440 nm.

In some implementations, λ₅ of the optical glass provided by the present invention is below 400 nm, as is preferably below 390 nm, and λ₅ is more preferably below 380 nm.

### <Acid Resistance Stability>

The acid resistance stability (D_{A}) (powder method) of the optical glass is tested as per the method specified in GB/T 17129.

In some implementations, the acid resistance stability (D_{A}) of the optical glass provided by the present invention is above Class 2, preferably Class 1.

### <Water Resistance Stability>

The water resistance stability (D_{W}) (powder method) of the optical glass is tested as per the method specified in GB/T 17129.

In some implementations, the water resistance stability (D_{W}) of the optical glass provided by the present invention is above Class 2, preferably Class 1.

### <Upper Limit of Devitrification Temperature>

The devitrification performance of the glass is measured by a temperature gradient furnace method which comprises the following steps: processing the glass into 180×10×10 mm samples, polishing lateral sides, placing the samples into a furnace having a temperature gradient (10° C./cm) and heating up to 1300° C. in the highest temperature zone, taking out the samples for cooling to room temperature after keeping the temperature for 4 hours, and observing the devitrification of the glass under a microscope, wherein the maximum temperature corresponding to the appearance of crystal in the glass is the upper limit of devitrification temperature of the glass.

In some implementations, the upper limit of devitrification temperature of the optical glass provided by the present invention is below 1200° C., preferably below 1160° C., more preferably below 1150° C., further preferably below 1140° C.

### <Young's Modulus>

The Young's modulus (E) of the glass is tested by ultrasonic wave for P-wave velocity and S-wave velocity, and then calculated according to the following formula.

$$E = \frac{4 {G}^{2} - 3 G {V}_{T}^{2} ρ}{G - {V}_{T}^{2} ρ}$$

G=Vs²ρ

Wherein: E refers to Young's modulus, Pa;
G refers to shear modulus, Pa;
V_{T} refers to S-wave velocity, m/s;
V_{S} refers to P-wave velocity, m/s;
ρ refers to glass density, g/cm³.

In some implementations, Young's modulus (E) of the optical glass provided by the present invention is above 9000×10⁷/Pa, preferably above 9500×10⁷/Pa, more preferably above 10000×10⁷/Pa, further preferably above 10500×10⁷/Pa.

### <Thermal Expansion Coefficient>

The thermal expansion coefficient (α_{100˜300° C.}) of the optical glass is tested at 100-300° C. as per the method specified in GB/T 7962.16-2010.

The thermal expansion coefficient (α_{100˜300° C.}) of the optical glass provided by the present invention is below 110×10⁻⁷/K, preferably below 105×10⁻⁷/K, more preferably below 100×10⁻⁷/K.

### <Density>

The density (ρ) of the optical glass is tested as per the method specified in GB/T7962.20-2010.

In some implementations, density (p) of the optical glass provided by the present invention is below 4.30 g/cm³, preferably below 4.20 g/cm³, more preferably below 4.10 g/cm³.

### <Abrasion Degree>

Abrasion degree (F_{A}) of optical glass refers to the data obtained by the ratio of the abrasion quantity of sample to the abrasion quantity (volume) of the standard sample (H-K9 optical glass) multiplying by 100 with the formula below under exactly the same conditions:

$${F}_{A} = V / {V}_{0} \times 100 = ( W / ρ ) / ( {W}_{0} / {ρ}_{0} ) \times 100$$

Wherein: V—volume abrasion quantity of the tested sample;
V₀—volume abrasion quantity of the standard sample;
W—mass abrasion quantity of the tested sample;
W₀—mass abrasion quantity of the standard sample;
ρ—density of the tested sample;
ρ₀—density of the standard sample;

In some implementations, abrasiveness (F_{A}) of the optical glass provided by the present invention is above 150, preferably above 180, more preferably 200-300.

### <Relative Partial Dispersion>

The relative partial dispersion of wavelengths x and y is expressed by the following formula (1):

$${P}_{x , y} = ( {n}_{x} - {n}_{y} ) / ( {n}_{F} - {n}_{C} ) \qquad ( 1 )$$

According to the Abbe number formula, the following formula (2) is valid for most of the so-called “normal glass” (H-K6 and F4 are selected as the “normal glass” below).

$${p}_{x , y} = {m}_{x , y} \cdot {v}_{d} + {b}_{x , y} \qquad ( 2 )$$

This linear relationship is represented by P_{x,y} as vertical coordinate and v_{d} as horizontal coordinate, in which m_{x,y} refers to the slope, and b_{x,y} refers to the intercept.

As we all know, the correction of secondary spectrum, that is, achromatic for more than two wavelengths, requires at least one glass that does not conform to the above formula (2) (that is, its P_{x,y} value deviates from the empirical formula of Abbe number), with deviation value expressed by ΔP_{x,y}, and then each P_{x,y}-v_{d} point translates the quantity of ΔP_{x,y} relative to the “normal line” conforming to the above formula (2). In this case, the ΔP_{x,y} value of each glass can be calculated by the following formula (3):

$${P}_{x , y} = {m}_{x , y} \cdot {y}_{d} + {b}_{x , y} + Δ {P}_{x , y} \qquad ( 3 )$$

Therefore, it can be known from the above that the calculation formula of the relative partial dispersion (P_{g,F}) is the following formula (4):

$${P}_{g , F} = ( {n}_{g} - {n}_{F} ) / ( {n}_{F} - {n}_{C} ) \qquad ( 4 )$$

In some implementations, the relative partial dispersion (P_{g,F}) of the optical glass provided by the present invention is 0.6000-0.6500, preferably 0.6100-0.6400, more preferably 0.6150-0.6250.

### <Devitrification Resistance of Secondary Compression>

The test method for devitrification resistance of secondary compression is as follows: cut the sample glass into 20×20×10 mm pieces, place into a muffle furnace with temperature as T_{g}+(200-250°) C for 15-30 minutes, then take out for cooling, and observe the surface and the inside for crystal or opacity. In case of no opacity and/or crystal in the glass sample, it means that the glass has excellent devitrification resistance of secondary compression.

### [Manufacturing Method]

The manufacturing method of the optical glass provided by the present invention is as follows: the glass of the present invention is made of conventional raw materials and processes, including but not limited to using oxide, hydroxide, fluoride, and various salts (carbonate, nitrate, sulfate, phosphate, and metaphosphate) as raw materials, mixing the ingredients according to the conventional method, and then feeding the mixed furnace burden into a 1000-1400° C. smelting furnace (e.g., platinum crucible) for melting, obtaining homogeneous molten glass without bubbles and undissolved substances after clarification and homogenization, shaping the molten glass in a mould, and performing annealing. Those skilled in the art can appropriately select raw materials, process methods and process parameters according to actual needs.

### [Glass Preform and Optical Element]

The glass preform can be made from the optical glass formed by, for example, direct drop forming, grinding or thermoforming, and other compression molding means. That is to say, the precision glass preform can be made by direct precision drop molding of molten optical glass, or glass preform can be made by grinding and other machining methods, or the glass preform can be made by making a preform for compression molding with the optical glass, re-thermoforming this preform, and then grinding the preform. It should be noted that the means for preparing glass preform is not limited to the above means.

As mentioned above, the optical glass of the present invention is useful for various optical elements and optical designs, wherein the particularly preferred method is to form a preform by the optical glass of the present invention, and use this preform for re-thermoforming, precision stamping and the like to make optical elements such as lens and prism.

The glass preform and the optical element of the present invention are both formed by the optical glass of the present invention described above. The glass preform of the present invention has excellent characteristics of the optical glass; the optical element of the present invention has excellent characteristics of the optical glass, and can provide such optical elements as a variety of lenses and prisms having a high optical value.

Examples of the lens include various lenses with spherical or aspheric surfaces, such as concave meniscus lens, convex meniscus lens, biconvex lens, biconcave lens, planoconvex lens and planoconcave lens.

### [Optical Instrument]

The optical element formed by the optical glass of the present invention can make optical instruments such as photographic equipment, camera equipment, projector equipment, display equipment, on-board equipment and monitoring equipment.

### Embodiment

### <Optical Glass Embodiment>

The following non-limiting embodiments are provided in order to further clearly explain and illustrate the technical solution of the present invention.

This embodiment obtains the optical glass with composition as shown in Table 1-Table 4 by the manufacturing method of the above-mentioned optical glass. In addition, the characteristics of each glass are measured by the test method described in the present invention, and the measurement results are shown in Tables 1 to 4. In the devitrification resistance test of secondary compression in Tables 1 to 4, according to the aforesaid test method, the glass without opacity and crystal particle on the surface and inside is denoted as “A”, the glass without opacity and crystal particle inside, but with devitrification particle on the surface, is denoted as “B” (the devitrification particle on the surface of the glass can be removed by grinding during secondary compression, but the grinding cost will be increased, so the glass without devitrification particle inside and outside is more preferably selected), the glass without opacity, but with 1-10 crystal particles inside, is denoted as “C”, the glass without opacity, but with 10-20 crystal particles inside, is denoted as “D”, and the glass with opacity or dense devitrification particles inside is denoted as

TABLE 1

| Component (wt %) | 1# | 2# | 3# | 4# | 5# | 6# | 7# |
|---|---|---|---|---|---|---|---|
| SiO₂ | 15.5 | 17.5 | 22.4 | 24.2 | 18.6 | 16.5 | 26.2 |
| Nb₂O₅ | 17.3 | 15.4 | 10.6 | 8.5 | 18.5 | 16.7 | 6.5 |
| WO₃ | 0.5 | 0 | 0 | 0 | 0 | 2 | 3.4 |
| TiO₂ | 18.6 | 21.4 | 30.2 | 32.5 | 16.3 | 25.5 | 33.6 |
| B₂O₃ | 3.5 | 4.7 | 2 | 0.2 | 4.6 | 2.2 | 1.5 |
| ZnO | 1 | 0 | 3.2 | 0 | 0.5 | 0 | 0 |
| Li₂O | 0.5 | 0 | 0.5 | 0 | 0.3 | 0 | 0 |
| Na₂O | 1.6 | 3 | 0.5 | 1.9 | 2 | 2.3 | 3.6 |
| K₂O | 0 | 0 | 0 | 0 | 0 | 0.5 | 0 |
| SrO | 0 | 0.5 | 0 | 2 | 0 | 0 | 0 |
| BaO | 31 | 33.4 | 16.6 | 21.5 | 20.7 | 23.8 | 17.6 |
| MgO | 0 | 0 | 0 | 0.5 | 0 | 0 | 0 |
| CaO | 1.5 | 2 | 7.6 | 3.5 | 4.5 | 3.5 | 3 |
| La₂O₃ | 5 | 0.8 | 1.6 | 2.2 | 3.5 | 1.6 | 0 |
| Gd₂O₃ | 0 | 0 | 0.5 | 0 | 1 | 0 | 0 |
| Y₂O₃ | 0 | 0 | 0 | 0.5 | 0 | 0 | 0 |
| Yb₂O₃ | 0 | 0 | 0 | 0 | 0 | 0 | 0 |
| ZrO₂ | 3.8 | 1.3 | 4 | 2.5 | 8.5 | 5.4 | 4.5 |
| Al₂O₃ | 0 | 0 | 0.3 | 0 | 1 | 0 | 0 |
| Sb₂O₃ | 0.2 | 0 | 0 | 0 | 0 | 0 | 0.1 |
| SnO₂ | 0 | 0 | 0 | 0 | 0 | 0 | 0 |
| SnO | 0 | 0 | 0 | 0 | 0 | 0 | 0 |
| CeO₂ | 0 | 0 | 0 | 0 | 0 | 0 | 0 |
| Total | 100 | 100 | 100 | 100 | 100 | 100 | 100 |
| Nb₂O₅/BaO | 0.558 | 0.461 | 0.639 | 0.395 | 0.894 | 0.702 | 0.369 |
| TiO₂/(Nb₂O₅ + ZrO₂) | 0.882 | 1.281 | 2.068 | 2.955 | 0.604 | 1.154 | 3.055 |
| SiO₂/(Nb₂O₅ + TiO₂) | 0.432 | 0.476 | 0.549 | 0.59 | 0.534 | 0.391 | 0.653 |
| B₂O₃/SiO₂ | 0.226 | 0.269 | 0.089 | 0.008 | 0.247 | 0.133 | 0.057 |
| Na₂O/CaO | 1.067 | 1.5 | 0.066 | 0.543 | 0.444 | 0.657 | 1.200 |
| (ZnO + SrO + Ln₂O₃)/SiO₂ | 0.387 | 0.074 | 0.237 | 0.194 | 0.215 | 0.097 | 0 |
| Li₂O/B₂O₃ | 0.143 | 0 | 0.25 | 0 | 0.065 | 0 | 0 |
| (SiO₂ + TiO₂)/(Nb₂O₅ + | 0.636 | 0.747 | 1.356 | 1.575 | 0.667 | 0.85 | 1.892 |
| ZrO₂ + CaO + BaO) | | | | | | | |
| 10 × Li₂O/Nb₂O₅ | 0.289 | 0 | 0.472 | 0 | 0.162 | 0 | 0 |
| n_{d} | 1.93558 | 1.90878 | 1.92634 | 1.92145 | 1.89083 | 1.95848 | 1.89024 |
| v_{d} | 24.05 | 24.27 | 24.33 | 22.68 | 25.20 | 23.20 | 22.90 |
| λ₇₀(nm) | 456 | 423 | 444 | 441 | 419 | 447 | 450 |
| λ₅(nm) | 374 | 371 | 381 | 380 | 368 | 376 | 382 |
| D_{A} | Class 1 | Class 1 | Class 1 | Class 1 | Class 1 | Class 1 | Class 1 |
| D_{W} | Class 1 | Class 1 | Class 1 | Class 1 | Class 1 | Class 1 | Class 1 |
| Upper limit of | 1130 | 1130 | 1140 | 1150 | 1120 | 1160 | 1140 |
| devitrification | | | | | | | |
| temperature (° C.) | | | | | | | |
| E(×10⁷/Pa) | 11058 | 11067 | 11075 | 11036 | 10342 | 11128 | 11027 |
| α_{100~300° C.}(×10⁻⁷/K) | 97 | 93 | 92 | 94 | 98 | 102 | 91 |
| ρ(g/cm³) | 4.06 | 3.98 | 3.92 | 3.92 | 3.87 | 4.08 | 3.80 |
| F_{A} | 252 | 265 | 285 | 240 | 263 | 235 | 260 |
| P_{g, F} | 0.6213 | 0.6209 | 0.6226 | 0.6229 | 0.6199 | 0.6217 | 0.6220 |
| Devitrification resistance | B | A | B | A | B | A | A |
| of secondary compression | | | | | | | |

TABLE 2

| Component ( wt %) | 8# | 9# | 10# | 11# | 12# | 13# | 14# |
|---|---|---|---|---|---|---|---|
| SiO₂ | 19.5 | 20.4 | 23.6 | 18 | 18.5 | 21.4 | 22.5 |
| Nb₂O₅ | 14.6 | 13.2 | 12.5 | 10 | 11.6 | 12.5 | 13.7 |
| WO₃ | 0 | 0 | 0 | 0 | 0 | 0 | 0 |
| TiO₂ | 22.5 | 23.6 | 26.4 | 26.2 | 28.5 | 25.3 | 27.2 |
| B₂O₃ | 2.6 | 3.4 | 1.8 | 2 | 2.5 | 2.1 | 2 |
| ZnO | 2 | 0 | 0 | 0 | 1.2 | 0 | 0 |
| Li₂O | 0.8 | 0 | 0 | 0 | 0 | 0 | 0 |
| Na₂O | 1.5 | 0.6 | 2.2 | 2.5 | 2.4 | 1.5 | 1.7 |
| K₂O | 0 | 0 | 0 | 0 | 0 | 0 | 0 |
| SrO | 1.2 | 0 | 0 | 0 | 0 | 0 | 0.5 |
| BaO | 22.5 | 23.6 | 25.4 | 26.5 | 25.2 | 26.1 | 21.6 |
| MgO | 0 | 3 | 0 | 0 | 0 | 0 | 0 |
| CaO | 6.5 | 4 | 2.2 | 5 | 3.5 | 5.5 | 2.4 |
| La₂O₃ | 2.5 | 3.3 | 3.4 | 5 | 2.4 | 1.5 | 2.2 |
| Gd₂O₃ | 0 | 0 | 0 | 0 | 0 | 0 | 0 |
| Y₂O₃ | 0 | 0 | 0 | 0 | 0 | 0 | 0 |
| Yb₂O₃ | 0 | 0 | 0 | 0 | 0 | 0 | 0 |
| ZrO₂ | 3.8 | 4.8 | 2.5 | 4.8 | 4.2 | 4.1 | 6.1 |
| Al₂O₃ | 0 | 0 | 0 | 0 | 0 | 0 | 0 |
| Sb₂O₃ | 0 | 0.1 | 0 | 0 | 0 | 0 | 0.1 |
| SnO₂ | 0 | 0 | 0 | 0 | 0 | 0 | 0 |
| SnO | 0 | 0 | 0 | 0 | 0 | 0 | 0 |
| CeO₂ | 0 | 0 | 0 | 0 | 0 | 0 | 0 |
| Total | 100 | 100 | 100 | 100 | 100 | 100 | 100 |
| Nb₂O₅/BaO | 0.649 | 0.559 | 0.492 | 0.377 | 0.46 | 0.479 | 0.634 |
| TiO₂/(Nb₂O₅ + ZrO₂) | 1.223 | 1.311 | 1.76 | 1.77 | 1.804 | 1.524 | 1.374 |
| SiO₂/(Nb₂O₅ + TiO₂) | 0.526 | 0.554 | 0.607 | 0.497 | 0.461 | 0.566 | 0.55 |
| B₂O₃/SiO₂ | 0.133 | 0.167 | 0.076 | 0.111 | 0.135 | 0.098 | 0.089 |
| Na₂O/CaO | 0.231 | 0.15 | 1 | 0.5 | 0.686 | 0.273 | 0.708 |
| (ZnO + SrO + Ln₂O₃)/SiO₂ | 0.292 | 0.162 | 0.144 | 0.278 | 0.195 | 0.07 | 0.12 |
| Li₂O/B₂O₃ | 0.308 | 0 | 0 | 0 | 0 | 0 | 0 |
| (SiO₂ + TiO₂)/ | 0.886 | 0.965 | 1.174 | 0.955 | 1.056 | 0.969 | 1.135 |
| (Nb₂O₅ + ZrO₂ + | | | | | | | |
| CaO + BaO) | | | | | | | |
| 10 × Li₂O/Nb₂O₅ | 0.548 | 0 | 0 | 0 | 0 | 0 | 0 |
| n_{d} | 1.90278 | 1.89728 | 1.91078 | 1.92156 | 1.93898 | 1.90948 | 1.92498 |
| v_{d} | 24.55 | 24.44 | 23.99 | 24.32 | 23.45 | 24.12 | 23.48 |
| λ₇₀ (nm) | 428 | 433 | 432 | 432 | 440 | 428 | 444 |
| λ₅ (nm) | 372 | 372 | 373 | 374 | 376 | 373 | 374 |
| D_{A} | Class 1 | Class 1 | Class 1 | Class 1 | Class 1 | Class 1 | Class 1 |
| D_{W} | Class 1 | Class 1 | Class 1 | Class 1 | Class 1 | Class 1 | Class 1 |
| Upper limit of | 1120 | 1100 | 1120 | 1130 | 1140 | 1130 | 1120 |
| devitrification | | | | | | | |
| temperature (° C.) | | | | | | | |
| E (×10⁷/Pa) | 11036 | 11074 | 11130 | 11133 | 11152 | 11026 | 11142 |
| α_{100~300° C.} (×10⁻⁷/K) | 92 | 92 | 95 | 95 | 94 | 95 | 93 |
| ρ (g/cm³) | 3.89 | 3.88 | 3.94 | 3.98 | 4.02 | 3.94 | 3.95 |
| F_{A} | 290 | 245 | 258 | 280 | 268 | 270 | 262 |
| P_{g, F} | 0.6210 | 0.6208 | 0.6216 | 0.6219 | 0.6226 | 0.6210 | 0.6220 |
| Devitrification resistance | B | A | A | A | A | A | A |
| of secondary compression | | | | | | | |

TABLE 3

| Component ( wt %) | 15# | 16# | 17# | 18# | 19# | 20# | 21# |
|---|---|---|---|---|---|---|---|
| SiO₂ | 17.4 | 23.6 | 22.5 | 18 | 20.5 | 16.7 | 18.65 |
| Nb₂O₅ | 13.1 | 14.4 | 10.5 | 8 | 11.6 | 12.3 | 8.65 |
| WO₃ | 0 | 0 | 0 | 0 | 0 | 0 | 0 |
| TiO₂ | 29.1 | 24.5 | 26.1 | 28.2 | 21.6 | 24.3 | 28.1 |
| B₂O₃ | 1.6 | 1.4 | 1.7 | 2 | 3.2 | 5 | 2 |
| ZnO | 0.5 | 0 | 0 | 0 | 0 | 0 | 0 |
| Li₂O | 0.6 | 0.2 | 0 | 0 | 0 | 0 | 0 |
| Na₂O | 2.4 | 1.6 | 1.4 | 2.5 | 1.3 | 2 | 2.5 |
| K₂O | 0 | 0 | 0 | 0 | 0 | 0 | 0 |
| SrO | 0 | 0 | 1.5 | 1.5 | 3 | 0 | 0 |
| BaO | 24.5 | 19.5 | 23.6 | 25.5 | 22.6 | 27.5 | 27.7 |
| MgO | 0 | 0 | 0 | 0 | 0 | 0 | 0 |
| CaO | 2.8 | 10 | 3.5 | 4.5 | 1.4 | 4.3 | 4.55 |
| La₂O₃ | 2.6 | 3.1 | 3.5 | 5 | 6 | 2.5 | 3 |
| Gd₂O₃ | 0 | 0 | 0 | 0 | 2 | 0 | 0 |
| Y₂O₃ | 0 | 0 | 0 | 0 | 0 | 1 | 0 |
| Yb₂O₃ | 0 | 0 | 0 | 0 | 0 | 0 | 0 |
| ZrO₂ | 5.4 | 1.6 | 5.7 | 4.8 | 6.8 | 4.4 | 4.85 |
| Al₂O₃ | 0 | 0 | 0 | 0 | 0 | 0 | 0 |
| Sb₂O₃ | 0 | 0 | 0 | 0 | 0 | 0 | 0 |
| SnO₂ | 0 | 0 | 0 | 0 | 0 | 0 | 0 |
| SnO | 0 | 0.1 | 0 | 0 | 0 | 0 | 0 |
| CeO₂ | 0 | 0 | 0 | 0 | 0 | 0 | 0 |
| Total | 100 | 100 | 100 | 100 | 100 | 100 | 100 |
| Nb₂O₅/BaO | 0.535 | 0.738 | 0.445 | 0.314 | 0.513 | 0.447 | 0.312 |
| TiO₂/(Nb₂O₅ + ZrO₂) | 1.573 | 1.531 | 1.611 | 2.203 | 1.174 | 1.455 | 2.081 |
| SiO₂/(Nb₂O₅ + TiO₂) | 0.412 | 0.607 | 0.615 | 0.497 | 0.617 | 0.456 | 0.507 |
| B₂O₃/SiO₂ | 0.092 | 0.059 | 0.076 | 0.111 | 0.156 | 0.299 | 0.107 |
| Na₂O/CaO | 0.857 | 0.16 | 0.4 | 0.556 | 0.929 | 0.465 | 0.549 |
| (ZnO + SrO + Ln₂O₃)/SiO₂ | 0.178 | 0.131 | 0.222 | 0.241 | 0.537 | 0.21 | 0.161 |
| Li₂O/B₂O₃ | 0.375 | 0.143 | 0 | 0 | 0 | 0 | 0 |
| (SiO₂ + TiO₂)/ | 1.015 | 1.057 | 1.122 | 1.079 | 0.993 | 0.845 | 1.022 |
| (Nb₂O₅ + ZrO₂ + | | | | | | | |
| CaO + BaO) | | | | | | | |
| 10 × Li₂O/Nb₂O₅ | 0.458 | 0.139 | 0 | 0 | 0 | 0 | 0 |
| n_{d} | 1.95988 | 1.89038 | 1.90096 | 1.92628 | 1.90216 | 1.92392 | 1.92357 |
| v_{d} | 23.22 | 24.49 | 24.62 | 23.96 | 24.74 | 24.18 | 23.85 |
| λ₇₀ (nm) | 445 | 436 | 425 | 435 | 421 | 435 | 435 |
| λ₅ (nm) | 384 | 370 | 372 | 374 | 370 | 374 | 375 |
| D_{A} | Class 1 | Class 1 | Class 1 | Class 1 | Class 1 | Class 1 | Class 1 |
| D_{W} | Class 1 | Class 1 | Class 1 | Class 1 | Class 1 | Class 1 | Class 1 |
| Upper limit of | 1150 | 1130 | 1100 | 1120 | 1110 | 1130 | 1130 |
| devitrification | | | | | | | |
| temperature (° C.) | | | | | | | |
| E (×10⁷/Pa) | 11135 | 11122 | 11137 | 11138 | 11026 | 10537 | 11135 |
| α_{100~300° C.} (×10⁻⁷/K) | 96 | 94 | 92 | 94 | 97 | 94 | 96 |
| ρ (g/cm³) | 4.11 | 3.82 | 3.87 | 3.98 | 3.92 | 4.00 | 3.97 |
| F_{A} | 287 | 264 | 265 | 275 | 254 | 257 | 267 |
| P_{g, F} | 0.6228 | 0.6212 | 0.6214 | 0.6222 | 0.6209 | 0.6214 | 0.6220 |
| Devitrification resistance | B | A | A | A | A | B | A |
| of secondary compression | | | | | | | |

TABLE 4

| Component (wt %) | 22# | 23# |
|---|---|---|
| SiO₂ | 16.4 | 18.25 |
| Nb₂O₅ | 7 | 13.2 |
| WO₃ | 0 | 0 |
| TiO₂ | 28.2 | 25.6 |
| B₂O₃ | 4 | 1.85 |
| ZnO | 0 | 0 |
| Li₂O | 0 | 0.65 |
| Na₂O | 2.5 | 2.35 |
| K₂O | 0 | 0 |
| SrO | 0 | 0 |
| BaO | 28.4 | 23.6 |
| MgO | 0 | 0 |
| CaO | 3.5 | 6.55 |
| La₂O₃ | 5.6 | 3.2 |
| Gd₂O₃ | 0 | 0 |
| Y₂O₃ | 0 | 0 |
| Yb₂O₃ | 0 | 0 |
| ZrO₂ | 4.4 | 4.75 |
| Al₂O₃ | 0 | 0 |
| Sb₂O₃ | 0 | 0 |
| SnO₂ | 0 | 0 |
| SnO | 0 | 0 |
| CeO₂ | 0 | 0 |
| Total | 100 | 100 |
| Nb₂O₅/BaO | 0.246 | 0.559 |
| TiO₂/(Nb₂O₅ + ZrO₂) | 2.474 | 1.426 |
| SiO₂/(Nb₂O₅ + TiO₂) | 0.466 | 0.47 |
| B₂O₃/SiO₂ | 0.244 | 0.101 |
| Na₂O/CaO | 0.714 | 0.359 |
| (ZnO + SrO + Ln₂O₃)/SiO₂ | 0.341 | 0.175 |
| Li₂O/B₂O₃ | 0 | 0.351 |
| (SiO₂ + TiO₂)/ | 1.03 | 0.912 |
| (Nb₂O₅ + ZrO₂ + CaO + BaO) | | |
| 10 × Li₂O/Nb₂O₅ | 0 | 0.492 |
| n_{d} | 1.92364 | 1.92778 |
| v_{d} | 24.01 | 24.05 |
| λ₇₀ (nm) | 439 | 436 |
| λ₅ (nm) | 376 | 373 |
| D_{A} | Class 1 | Class 1 |
| D_{W} | Class 1 | Class 1 |
| Upper limit of devitrification | 1130 | 1120 |
| temperature (° C.) | | |
| E (×10⁷/Pa) | 11145 | 11136 |
| α_{100~300° C.} (×10⁻⁷/K) | 95 | 93 |
| ρ (g/cm³) | 3.98 | 3.99 |
| F_{A} | 276 | 268 |
| P_{g·F} | 0.6222 | 0.6218 |
| Devitrification resistance of | A | B |
| secondary compression | | |

### <Glass Preform Embodiment>

The glass obtained by Embodiments 1-23 of the optical glass is made into a variety of lenses and prisms and other preforms such as concave meniscus lens, convex meniscus lens, biconvex lens, biconcave lens, planoconvex lens, and planoconcave lens by means of, for example, grinding, or re-thermoforming, precision stamping and other compression molding methods.

### <Optical Element Embodiment>

The preforms obtained in the above-mentioned glass preform embodiment are annealed for fine-tuning while reducing the deformation inside the glass, so that the optical characteristics such as the refractive index are brought to the desired values.

Then, each of the preforms is ground and polished, and a variety of lenses and prisms such as concave meniscus lens, convex meniscus lens, biconvex lens, biconcave lens, planoconvex lens, and planoconcave lens are prepared. An anti-reflection film may be coated on the surface of the obtained optical element.

### <Embodiments of Optical Instrument>

Through optical design and the use of one or more optical elements to form optical component or optical assembly, the optical element prepared by the above-mentioned optical element embodiment can be used, for example, in imaging device, sensor, microscope, medical technology, digital projection, communication, optical communication technology/information transmission, optics/lighting in the automobile field, photolithography, excimer laser, wafer, computer chip, and integrated circuit and electronic device including such circuit and chip, or camera device and apparatus used in the field of on-board products.

1-17. (canceled)

18. An optical glass, wherein components thereof are represented by weight percentage, comprising: 12-30% of SiO₂; 6-20% of Nb₂O₅; 15-35% of TiO₂; 15-35% of BaO; 1-10% of ZrO₂.

19. The optical glass according to claim 18, wherein components thereof are represented by weight percentage, further comprising: 0-6% of B₂O₃; and/or 0-10% of WO₃; and/or 0-8% of ZnO; and/or 0-3% of Li₂O; and/or 0-8% of Na₂O; and/or 0-5% of K₂O; and/or 0-8% of SrO; and/or 0-12% of CaO; and/or 0-8% of MgO; and/or 0-10% of Ln₂O₃; and/or 0-5% of Al₂O₃; and/or 0-1% of clarifying agent, the Ln₂O₃ is one or more of La₂O₃, Gd₂O₃, Y₂O₃, and Yb₂O₃, and the clarifying agent is one or more of Sb₂O₃, SnO₂, SnO, and CeO₂.

20. The optical glass according to claim 18, wherein components thereof are represented by weight percentage, and one or more of the following 9 conditions are satisfied:
1) Nb₂O₅/BaO is 0.2-1.2;
2) TiO₂/(Nb₂O₅+ZrO₂) is 0.6-5.5;
3) SiO₂/(Nb₂O₅+TiO₂) is 0.3-1.3;
4) B₂O₃/SiO₂ is below 0.4;
5) Na₂O/CaO is below 5.0;
6) (ZnO+SrO+Ln₂O₃)/SiO₂ is below 0.7;
7) Li₂O/B₂O₃ is below 0.5;
8) (SiO₂+TiO₂)/(Nb₂O₅+ZrO₂+CaO+BaO) is 0.5-2.2;
9) 10×Li₂O/Nb₂O₅ is below 0.7, and the Ln₂O₃ is one or more of La₂O₃, Gd₂O₃, Y₂O₃, and Yb₂O₃.

21. The optical glass according to claim 18, wherein components thereof are represented by weight percentage, and one or more of the following 9 conditions are satisfied:
1) Nb₂O₅/BaO is 0.2-1.0;
2) TiO₂/(Nb₂O₅+ZrO₂) is 0.7-4.0;
3) SiO₂/(Nb₂O₅+TiO₂) is 0.35-1.0;
4) B₂O₃/SiO₂ is 0.01-0.3;
5) Na₂O/CaO is 0.01-3.0;
6) (ZnO+SrO+Ln₂O₃)/SiO₂ is below 0.6;
7) Li₂O/B₂O₃ is below 0.3;
8) (SiO₂+TiO₂)/(Nb₂O₅+ZrO₂+CaO+BaO) is 0.6-2.0;
9) 10×Li₂O/Nb₂O₅ is below 0.4, and the Ln₂O₃ is one or more of La₂O₃, Gd₂O₃, Y₂O₃, and Yb₂O₃.

22. The optical glass according to claim 18, wherein components thereof are represented by weight percentage, and one or more of the following 9 conditions are satisfied:
1) Nb₂O₅/BaO is 0.25-0.9;
2) TiO₂/(Nb₂O₅+ZrO₂) is 0.8-3.0;
3) SiO₂/(Nb₂O₅+TiO₂) is 0.4-0.8;
4) B₂O₃/SiO₂ is 0.03-0.2;
5) Na₂O/CaO is 0.05-2.5;
6) (ZnO+SrO+Ln₂O₃)/SiO₂ is below 0.5;
7) Li₂O/B₂O₃ is below 0.1;
8) (SiO₂+TiO₂)/(Nb₂O₅+ZrO₂+CaO+BaO) is 0.8-1.8;
9) 10×Li₂O/Nb₂O₅ is below 0.2, and the Ln₂O₃ is one or more of La₂O₃, Gd₂O₃, Y₂O₃, and Yb₂O₃.

23. The optical glass according to claim 18, wherein components thereof are represented by weight percentage, and one or more of the following 5 conditions are satisfied:
1) Nb₂O₅/BaO is 0.3-0.8;
2) TiO₂/(Nb₂O₅+ZrO₂) is 1.0-2.5;
3) (ZnO+SrO+Ln₂O₃)/SiO₂ is below 0.3;
4) Li₂O/B₂O₃ is below 0.05;
5) (SiO₂+TiO₂)/(Nb₂O₅+ZrO₂+CaO+BaO) is 0.9-1.5, and the Ln₂O₃ is one or more of La₂O₃, Gd₂O₃, Y₂O₃, and Yb₂O₃.

24. The optical glass according to claim 18, wherein components thereof are represented by weight percentage, in which: SiO₂ is 16-23%; and/or Nb₂O₅ is 8-17%; and/or TiO₂ is 20-30%; and/or BaO is 20-30%; and/or ZrO₂ is 2-7%; and/or B₂O₃ is 0.5-4%; and/or WO₃ is 0-2%; and/or ZnO is 0-2%; and/or Li₂O is 0-1%; and/or Na₂O is 0.5-5%; and/or K₂O is 0-2%; and/or SrO is 0-2%; and/or CaO is 3-7%; and/or MgO is 0-2%; and/or Ln₂O₃ is 0-7%; and/or Al₂O₃ is 0-2%; and/or clarifying agent is 0-0.2%, the Ln₂O₃ is one or more of La₂O₃, Gd₂O₃, Y₂O₃, and Yb₂O₃, and the clarifying agent is one or more of Sb₂O₃, SnO₂, SnO, and CeO₂.

25. The optical glass according to claim 18, wherein components thereof do not contain ZnO; and/or do not contain Li₂O; and/or do not contain P₂O₅; and/or do not contain Bi₂O₃; and/or do not contain Ta₂O₅; and/or do not contain TeO₂, and/or do not contain WO₃.

26. The optical glass according to claim 18, wherein a refractive index n_{d} of the optical glass is 1.89-1.96, and an Abbe number v_{d} is 20-28.

27. The optical glass according to claim 18, wherein the refractive index n_{d} of the optical glass is 1.91-1.94, and the Abbe number v_{d} is 22-26.

28. The optical glass according to claim 18, wherein λ₇₀ of the optical glass is below 460 nm; and/or λ₅ is below 400 nm; and/or acid resistance stability D_{A} is above Class 2; and/or water resistance stability D_{W} is above Class 2; and/or upper limit of devitrification temperature is below 1200° C.; and/or Young's modulus E is above 9000×10⁷/Pa; and/or thermal expansion coefficient α_{100˜300° C.} is below 110×10⁻⁷/K; density ρ is below 4.30 g/cm³; and/or abrasion degree f_{A} is above 150; and/or relative partial dispersion P_{g,F} is 0.6000-0.6500.

29. The optical glass according to claim 18, wherein λ₇₀ of the optical glass is below 440 nm; and/or λ₅ is below 380 nm; and/or acid resistance stability D_{A} is Class 1; and/or water resistance stability D_{W} is Class 1; and/or upper limit of devitrification temperature is below 1150° C.; and/or Young's modulus E is above 10000×10⁷/Pa; and/or thermal expansion coefficient α_{100˜300° C.} is below 100×10⁻⁷/K; density ρ is below 4.10 g/cm³; and/or abrasion degree F_{A} is 200-300; and/or relative partial dispersion P_{g,F} is 0.6150-0.6250.

30. A glass preform, made of the optical glass according to claim 18.

31. An optical element, made of the optical glass according to claim 18.

32. An optical instrument, comprising the optical glass according to claim 18.

33. An optical element, made of the glass preform according to claim 30.

34. An optical instrument, comprising the optical element according to claim 31.
